(19) United States
(12) Patent Application Publication
(10) Pub. No.: US 2016/0307156 A1
(43) Pub. Date: Oct. 20, 2016

(54) System and Method of Issuing and Monitoring Electronic Citations

(71) Applicant: Quicket Solutions, Inc., Lemont, IL (US)

(72) Inventor: Christiaan Burner, Lemont, IL (US)

(73) Assignee: Quicket Solutions, Inc., Lemont, IL (US)

(21) Appl. No.: 14/666,909

(22) Filed: Mar. 24, 2015

Related U.S. Application Data
(60) Provisional application No. 61/970,235, filed on Mar. 25, 2014.

(51) Int. Cl. G06Q 10/10; G06Q 50/18; H04L 29/06; G06Q 50/26

(52) U.S. Cl. CPC G06Q 10/10; G06Q 50/265; G06Q 50/18; H04L 63/10

(57) ABSTRACT

This invention relates a method and system of issuing and monitoring electronic citations for use in the law enforcement, public safety agencies, and judicial systems. This system and method of issuing and monitoring securely collects, transmits, stores, exports, and generates reports for the issuance of citations and the continued monitoring and transmittal of the citation to the appropriate entity.

### CROSS-REFERENCE TO RELATED APPLICATIONS

This application relates to and claims priority to U.S. Provisional Application 61/970,235 filed on Mar. 25, 2014 entitled System and Method of Issuing and Monitoring Electronic Citations.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LIST COMPACT DISC APPENDIX

Not applicable.

### BACKGROUND OF THE INVENTION

When an event occurs that runs afoul of certain laws, rules, or regulations a citation may be issued to an individual involved in the event or a report may be generated regarding the event. Typically the issuance of a citation or report is generated from an authorized officer of a governmental body that has jurisdiction over the area where the event occurred. In cases of an accident, crime, traffic violations, or other public safety violations, the citation is issued by a law enforcement officer. However, there are other agencies that may be empowered to issue citations such as building inspectors or inspectors of other public safety agencies.

Typically, an authorized officer issues a citation by writing up a form by hand. Some jurisdiction's allow for the issuance of electronic citations but still may require some additional items to be entered by hand, such as a depiction of an accident scene as an example. Even when an officer has access to electronic citation issuing, this is simply so the citation is typed and printed clearly. After the citation has been issued, the individual receiving the citation is given a copy and a copy is filed with the authorized officer for processing at that officer's agency. This system has worked for many governmental entities in that both the individual and governmental entities are in receipt of the citation and report and that the governmental body can file and access a citation when needed. However, the problem with this system is that citations may be lost, errors may still be accidentally imputed on a citation and there is no way that an officer can cross-check the information in the field to determine whether or not there is an outstanding issue, such as an outstanding warrant, on the individual. If the authorized officer does check this information, the authorized officer must access an external database separately or call in a request using a separate system for additional information. In more advanced systems, electronic citations may be stored on the computer device after completion and then later uploaded to a local server, typically housed in a government building, such as a police station. This data, including citations and other reports generated in the field, are then only retrievable on computers within the government building. In order to send this information to external stakeholders, the citations or other reports must be either printed and delivered or sent via email messaging. External users however have no method of accessing, searching, or retrieving the locally stored files. Essentially, the current environment does not allow for the easy exchange of records or other information because there is no central repository and the separate systems are incompatible.

The problem with the current solutions to ticketing is that there is no efficient way to securely collect, transmit, store, share, or export data collected from events and then be able to generate a report or citation from those events that is cross-checked between a number of public safety agencies and provides feedback that may need useful to an authorized officer issuing a citation or report in response to an event. This invention solves the above-mentioned problems by utilizing a system and method of issuing a citation or report regarding an event that is collected and cross-checked in an accurate and efficient manner. In addition, this invention also solves the issue with sharing of citations and other reports once they have been generated and submitted by authorized officers. With this invention, citations and reports can be easily viewed, modified, and exported by any authorized users of this system. With this invention, this information is accessible over a wide geographical area to authorized users of this system.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### BRIEF SUMMARY OF THE INVENTION

This invention relates a system and method of issuing and monitoring electronic citations for use in the law enforcement, public safety agencies, and judicial systems. This system and method of issuing and monitoring securely collects, transmits, stores, exports, and generates reports for the issuance of citations and the continued monitoring and transmittal of the citations to the appropriate entity in real time.

Namely, this system of issuing and monitoring citations comprises:
an electronic device equipped with software for issuing and monitoring citations linked to at least one secure server;

wherein an authorized user collects and enters data regarding an event and transmits/posts the information to at least one secure/encrypted backend through various methods such as through SOAP or HTTP transfer protocols for a cross-check for accuracy, completeness, or for more information regarding the citation; and transmits the citation to an appropriate agency for monitoring or processing and storing within a secure/encrypted backend and sends permission to issue a citation to at least one individual or entity.

Further, this method of issuing, monitoring, and sharing citations comprises the steps of:

an authorized user using an electronic device to log into software equipped with means to issue and monitor citations;

the authorized user collecting data from at least one individual or event regarding that event that would trigger the issuance of a citation or need to collect more information and enters the data into the software;

submitting the data to an appropriate agency wherein at least one secure server accepts, processes, manipulates and stores the data for completeness, accuracy, or for the purposes of informing the authorized user of additional information that may be relevant to the person;

at least one secure server sends a response back to the authorized user's electronic device as to whether the data is acceptable or not; and

the authorized user issuing a citation to at least one individual.

The electronic device is preferred to be a mobile data collection device, such as a cellular phone or tablet. This is preferred because of the small size and portability of such devices. However, one skilled in the art will recognize that other electronic devices such as personal computers may also be used. Any such electrical device may be utilized so long as it is able to function while in the field and can transmit and receive information electronically. This electronic device is preferred to be equipped with an industry standard card reader capable of reading a magnetic strip and/or embedded chips (for processing credit card payments and/or reading security credentials), a multi-dimensional scanner capable of reading 1D/2D images (for obtaining driver's license or other card/personal identification information), fingerprint reader, a camera, a microphone, and a printer or access to a printer.

To use this invention, a user must first login to the software equipped on the electronic device. Appropriate credentials may be entered for multi-factor authentication in the form of a user name and password followed by swiping an identification card for access. One skilled in the art will recognize that any number of ways of entering security credentials may be employed depending on the needs of a user or other requirements. Once the credentials are entered into the application interface, a request is sent to a secure server for authentication and approval. The secure backend server houses a listing of authorized persons and the credentials are cross-checked against the list. If there is a match, then the login was successful and the user is permitted access to the software. If there is not match, then login is unsuccessful and no access to the application interface is given.

All critical information such as the latest software updates, validators, court dates, violation descriptions, fine amount etc. are loaded in the device, retrieved from the backend after successful login. It is possible for the electronic device to load critical information on the device in real-time because of embedded wireless technology in each device and the constant availability of the backend server.

Authorized users are users who hold long-term credentialed access within the software. Examples of typical authorized users may include police officers, judicial clerks, building inspectors or other representatives of law enforcement, public safety agencies, and judicial systems.

The authorized user listing housed on the server also can be user-specific. This may mean that some users are given access to certain parts of the software and other user may have access to different parts of the software depending on a user's needs and/or functions. This list may also store preferences of a particular authorized user, such as font, color, font size, etc. of the displayed software. This list is anticipated to maintained and updated by an administrator and is likely influenced or governed by existing laws, regulations, or other rules.

The software may be web based or application based depending on the electronic device being used. One skilled in the art will recognize that both are equally anticipated.

When an authorized user, such as a police officer or building inspector, witnesses or is otherwise called to a scene of an event that requires the collection of data for the purpose of issuing a citation or other record, certain data must be collected and entered into the software. Data is entered into a variety of formats in accordance with pre-defined or dynamic parameters set by the software. The data collected is dependent on the type of citation, form, or report to be issued. The appropriate form is selected by the authorized user. A selection is anticipated to be made from a pre-set list of possible citation or report forms. For example, an officer may choose to issue a moving violation. In this case, an officer would simply select this citation type and a blank or partially and automatically populated form would be generated. Automatic population of the given citation or form would occur if an authorized user conducts a background search on the person or item of interest. Data for the background search may be gathered from various connected external remote databases, such as from the Department of Motor Vehicles or

Federal Bureau of Investigation, and an internally controlled remote database. The electronic device software will retrieve all relevant information via a wireless signal and the information will be displayed on the screen. An authorized user may then attach this gathered information to a form to automatically populate various information fields. This form is further equipped with a predefined list of information required for the entry of data that would result in the successful issuance of a citation or form. Information that can be gathered includes text, voice, photo, video, data file (in instance of using magnetic strip reader or multi-dimensional scanner), or biometric using the electronic device. Text fields can be completed by manual entry or through speech-to-text options. Some information, such as accident report evidence can be collected using an integrated camera for photo and video notes. Further, some information, such as personal information from a driver's license, may be collected and entered into a ticket automatically using magnetic strip reader, 1D/2D reader, or chip reader and connected via a wired or wireless option. Data collected in this manner can be processed by the software and properly sorted and entered into a variety of information fields automatically.

Once the authorized user has completed the necessary data collection on the selected citation, form, or other report, the data may be submitted to the server. It is anticipated that the authorized user will complete this by selecting a prompt to submit. Before the submission to the internal backend database occurs, first, the electronic devices will also have the capability to verify/validate all the information dynamically via use of a “checker”. If the user incorrectly inputs information, such as inputting numerical data for an information field dedicated to alphabetic text only, the interface would alert the authorized user of the issue. Once skilled in the art will recognize that there are multiple methods and options for checking for errors to ensure that data is inputted properly. Upon successful login to the device, the latest checkers will be downloaded to the electronic device from the internal backend database.

Once the data is submitted, the data is then encrypted on the electronic device. After successfully securing/encrypting the information, it is then transmitted via a secure connection over cellular or other wireless technology to a secure server via through various methods such as through SOAP or HTTP transfer protocols. The secure connection may employ methods such as SSL, TLS or other encryption certificates to ensure that the data is adequately encrypted during transmission.

The secure encrypted server is considered to be the backend system of this invention. The backend may comprise a set of servers or cloud computing infrastructure that is capable of accepting, processing, manipulating, and/or storing data. It is anticipated that multiple servers which hold a variety of information may work together to generate the information needed in issuing or monitoring a citation. One skilled in the art will recognize that a RESTful API is the preferred manner for the software to query data from the database, but other similar manners be employed. It is also anticipated that backend systems may be managed internally by this system or managed by an external entity.

External backend systems include a variety of local, state, and federal databases that process and store a variety of information. Some examples include databases maintained by departments of transportation, the secretary of state, state and local police departments, and the Federal Bureau of Investigation. The external backend systems serve as verification tools for data collected by the authorized user and inputted into the software. Data that is transmitted to these servers is verified against existing records that those external departments store on their own servers. It is preferred that any information or data sent to an external backend is only sent after being processed through the software's internal backend system. This ensures that the information transmitted to an external backend is in a format that the external backend can receive and understand. The software of this invention is able to translate the data collected by the authorized user into a format that can be received and understood by the external backend. Once processed and formatted, the data is sent to the applicable external databases on the external backend by HTTP protocols or by some other equally effective method. An important feature of this software is that it is able to communicate, send, and receive information from an external backend. Once the information is received by the external backend databases, a query shall be initiated of existing records. If matches are found between data collected by an authorized user and the data stored on the external backend, a positive identification has been made and more information may be gathered and sent to the authorized user. If no match has been found, the server will return a negative search result, indicating that the external backend databases have no additional information to send to an authorized user about a particular person, event, or other record.

The software of this invention shall also have its own internally managed relational database on the software backend that has a similar purpose of the external backend servers. The server backend can simultaneously verify incoming information against its own set of records. Information, originating from an authorized user, is passed through the same backend web application that also processes data to be sent to external backend databases. The relational database is queried and similar to the manner described above in external backend systems. If matches are found between data collected by an authorized user and the data stored on the backend, a positive identification has been made and more information may be gathered and sent to the authorized user. If no match has been found, the server will return a negative search result, indicating that the internal backend databases have no additional information to send to an authorized user about a particular person or event.

Information collected by both the internal and external backend on a person or object of interest shall be transmitted and displayed on the software interface of the electronic device. Such information may then be selected by the authorized user for the purpose of automatically appending or pasting such information to the appropriate data fields of a citation, report, or other form.

When the authorized user has completed a citation, form, or other report, he or she will attempt to submit the information using prompts provided on the electronic device interface. Before submission of such information to the internal backend, the electronic device software shall employ a “checker” that is capable of determining if there are any errors in the data input for the citation, form or other report. The software will be able to detect if certain data fields on the interface are left empty or information is incorrectly entered. This “checker” validates information against various rules for each data field on the electronic device.

Once the authorized user has corrected any errors that were determined by the electronic device “checker” software, the authorized user will have the ability to submit and transmit the citation, form, or other report via wireless communication to the internal backend. The system shall have a second “checker”, which validates information against the backend system—where additional information on the person or object of interest exists. Once this information is sent back to the backend servers, it is further validated, if required, for server specific issues such as formatting, color coding, and input values. One skilled in the art would recognize that there may be many more validators that the second “checker” shall employ to ensure that the citation, form, or report is free from errors and conforms to backend specifications for proper storage of such data.

If errors are found by the internal backend system, the citation, form, or report is returned via wireless communication to the electronic device. The authorized user will receive a message on the software interface that provides instructions on how to appropriately correct the citation, form, or other report. Once any changes have been made, the authorized user may again follow the prompts on the software interface to submit the data to the internal backend via wireless communication. The internal backend will then appropriately sort and store such data and when applicable automatically transmit such data to external backends. Anticipated external backends include servers maintained by courts, department of motor vehicles and local law enforcement agencies. However, one skilled in the art will recognize that the system internal backend will have the capability to send to any appropriate external backend as necessary for the relevant citation, form, or report.

The second “checker” further provides additional functionality to service custom requests from the authorized users using the electronic device software. The custom requests include updating, sharing, editing, deleting, and voiding existing citations, reports, or forms. The electronic device software shall have the capability of sending the appropriate custom request via wireless signal to the internal backend, locate the appropriate citation, form, or report, and then perform the designated custom request. One skilled in the art should recognize that other custom requests may be implemented that function through interaction and validation with the internal backend.

An authorized person may also be notified via a notification message on the electronic device software if there is a special circumstance that s/he needs to be aware of, such as a missing person report, expired license, outstanding warrants, etc. The authorized user will then have an opportunity to correct errors or act on a special circumstance. Such notifications may be generated with information determined by either or both the electronic device software or internal/external backend.

At times an authorized user may wish to submit a basic search query or an incomplete form to either or both of the external and software internal backend. An authorized user may submit data that results in a positive match but requires no further action by the authorized user. This may occur in a vehicle registration check, checking the validity of a driver's license, or checking to see if permits are accurate and up to date.

In one setting, after a citation, form, or report has been submitted, the individual receiving the citation or form (an “external user”) may have the option to pay the fine or make a payment for the issued citation for a single or multiple infractions. Some examples include, but are not limited to, payment for parking violations, bond payment, or moving violations. One skilled in the art will recognize the ability to pay at the scene may be dictated by certain laws, rules, or regulations to be determined by the issuing entity. In cases where a payment at the scene is authorized, an authorized user will be prompted by the software to ask the external user if s/he like to submit for payment processing immediately at the scene. If applicable, the external user supplies the authorized user with a form of payment. That form of payment is preferably a credit/debit card but other forms of payment may be accepted so long as software is authorized to receive that particular type of payment. In cases of a credit or debit card payment, the authorized user will utilize the card's magnetic strip or embedded chip to read the data using a supplied magnetic card reader or chip reader accessory. Via a wired or wireless connection, the payment data is encrypted and transmitted to the software on the electronic device. It is then transmitted over cellular or another wired or wireless signal to the system's payment processing server. One skilled in the art will recognize that the payment processing server may be integrated within the software internal backend system or part of an external backend. The financial information is verified and a response is generated by the server and sent back to the authorized user. If payment is accepted, the software will alert the authorized user that payment has been accepted and the citation or form will be marked as paid. If payment is denied, the software will alert the authorized user that the payment has been declined. This will then prompt the authorized user to try again with processing that payment type or to request another payment type. Once payment is denied, an authorized user may then also refuse payment and mark the citation or form as unpaid.

In another setting, after a citation, or form, or report has been submitted, the individual receiving the citation or form (an “external user”) may be required to appear in court. A court date can be automatically generated for the external user. This court date can be automatically assigned by taking into account a variety of factors. Such factors may include, the date of issuance of a citation, combined with predetermined assigned officer court dates, and the offense type, the system shall determine the appropriate court date and location assignment. The external user's electronic device can then retrieve such data from the internal backend. These factors may be adjusted in the system by authorized users using the web-based interface. The proper court date assignment will then be electronically stored with each electronic citation record as well as printed on the copy provided to the external user, (oftentimes known as the “offender” in the judicial system). One skilled in the art will recognize that there are many variables which may affect appropriate court date assignment and would recognize that there are a variety of ways in which such variables may be modified depending on the jurisdiction utilizing this system. Once the court date has been issued, the external user will have to either appear in court in a traditional manner or begin an adjudication process separately as part of this invention.

Once the citation has been generated and the option of immediate payment processing or court date issuance is complete, the citation or report is submitted as final. This data is encrypted on the electronic device and sent over a secure connection to the system's internal backend software for review. The data is processed according to set parameters defined by the citation, report, or form. This information will be stored on the software internal backend system and/or be transmitted to an external backend. If the transmission to the backend(s) is successful, the authorized user will receive a notice of confirmation of submission on the electronic device interface.

One skilled in the art may recognize that a final submission may not always be successful for a variety of reasons, including but not limited to, no connection being made to the backend due to down mobile or internet services or because of temporary issues with the software. In these circumstances, the submission will be encrypted and saved locally on the electronic device until the submission can be made. The software will continue to attempt to transmit the submission until successful. The software will recognize when such a submission is successful due to the response that it receives from the software's internal backend.

One skilled in the art may also recognize that there may be instances where a user does not wish to submit a citation, form, or report right away after completion. These will also be stored and encrypted locally and/or on the software backend on the electronic device and will be noted as incomplete. The software shall maintain a complete list of incomplete files. Each incomplete file will be uniquely assigned to a particular authorized user. This will ensure that when viewing the incomplete citation, form, or other report at a later time, the software only retrieves the files unique to that authorized user.

In most circumstances where a citation has been issued, the authorized user will wish or be required to provide the external user a copy of the citation for the external user's records. An authorized user may print a physical copy of the citation from a printer that is connected by wired or wireless means to the electronic device or may send the citation electronically to an external user. One method of sending a citation electronically is by electronic mail (email) but one skilled in the art may recognize that there are many other options for sending or sharing of these electronic citations.

When an authorized user decides to terminate use of the software on the electronic device, the authorized user simply logs out of the software. This terminates access to the software until appropriate credentials are re-entered. The logout process shall initiate a series of processes to remove information from the electronic device. A complete logout will then occur after all information has been erased from the electronic device. It is preferred for security purposes that no data shall be stored on the electronic device. If all information from the application session has been transmitted and stored successfully, the application shall erase all temporary data. However, as discussed above, there may be instances where data has failed to be transmitted to the software backend and will remain as encrypted data on the electronic device. In such an instance, the electronic device will attempt to transmit the information to the software backend when a cellular, wireless, or wired connection has been re-established. There may be instances whereby the authorized user will be able to temporary suspend/lock his or her application. In this case, the data will also be stored locally as encrypted data and will become accessible once the authorized user again logs in to the software.

This system may also allow access to external users to view some types of citations, forms, or reports through a records portal. If this is authorized, a user interface is presented to external users when visiting a specified website address. It is anticipated that each citation, form, or report will have its own unique identification number. This number assists in filing and then being able to recall the citation easily by reference. This unique identification number can be stored and associated with the correct records in the software backend and also be provided to the authorized user and external user on the printed or electronically transmitted citation, form, or other report. However, one skilled in the art may recognize that there are many other means to identify and call certain files from the records portal. Some examples of other unique identifiers include names, social security numbers, and license plate numbers. To view this data online through the records portal, an external user will navigate to the portion of the website that prompts the external user to provide either or both the unique identification number and other additional verification information, such as a last name, social security number or other identifying means. Once submitted, the interface will then transmit this information over a secure connection to the software backend for processing. Once a match has been found in the software backend database, the software backend will transmit over a secure connection the entire citation, form, or report associated with the unique identification number to the records portal on the computer being used currently by the external user. The software internal backend will have the capability of manipulating the data of the citation, form, or other report so that it is presented in an easy to read format.

Once a particular citation has been selected, the external user may view all information associated with the citation, form, or report as authorized by the software. Authorization is typically set by parameters defined by laws, rules, or regulations governing that citation, report, or other form. An external user may also be able to purchase access to a particular citation or record using a public web portal interface. This may prompt the records portal to request and collect payment. Once payment information has been entered, the records portal securely transmits this information to a backend for payment processing for verification. Upon verification of the payment information, the backend for payment processing will securely send this confirmation to the software backend. The software backend will then retrieve the citation, form, or reports associated with the unique identification number and securely transmit this information to the external user through the records portal. An external user may also have the option within the records portal to print or export the citation, form, or other report to a specific file format. Or, in some instances, the external user may be able to modify a citation or other record. This may occur when an external user provides or enters information or uploads additional information associated with that particular citation, report, or form if prompted to do so by the public web interface. It is anticipated that text, photos, and videos may be uploaded, but one skilled in the art may recognize that any file or data type may be provided by the external user and uploaded using the public web interface. Any additional information/files added shall be transmitted securely back to the software backend and stored within the software backend database. When an external user is done viewing records, the external user must log out or the system will do so automatically after a certain period of time. Upon logout, the information will no longer be viewable unless the external user re-enters the unique identification number and any other credentials necessary.

As discussed above, it is noted that an adjudication process may occur after the issuance of a citation. This adjudication process typically occurs after a citation has been generated and may occur at some time later or at a location separate from the actual citation generation. To initiate this adjudication process, the external user needs to begin by checking in. One option for check in is that an external user approaches kiosk or computer enabled with a web-based check-in interface. Each paper copy of the electronic citation provided to the external user shall include a barcode, which provides identification information for the citation. It is anticipated that a unique ticket number would be associated with each citation. The external user would have the ability to scan his or her citation using a barcode scanner attached to the kiosk. After successfully scanning the citation, the barcode information would be automatically transmitted to the internal backend and retrieve the appropriate electronic citation. A second option is that an external user approach the kiosk or computer and may register by manually searching for his or her citation by proving key information such as, but not limited to, citation number, driver's license number, license plate, etc. The kiosk further includes provide a keyboard for easily inputting information into the web-based interface. Once information has been entered successfully, the data shall be transmitted to the internal backend and retrieve the appropriate citation information. A third option may include an authorized user (such as court staff) utilizing a web-interface to check-in external users as an alternative to the self-service methods described above. These three options for check-in are listed for example purposes and it is anticipated by one skilled in the art that other options may be available.

After the external user registers with the system of this invention, the internal backend generates a roll call or list of registered citations. Further, the system shall be capable of appropriately sorting the citations and generating lists based on the proper location. The order in which electronic citations may be adjudicated may be based on a number of methods or rules, such as first-come-first serve, or alphabetical order.

The adjudication interface, accessed by authorized users, such as hearing officers or judges, shows the list of electronic citations registered for adjudication for the current day and location according to the order method described above. When a registered electronic citation is selected from the list in the adjudication web-interface, an authorized user is able to view the complete details of the electronic citation, such as the offense type, location of the offense, and any other information collected when the electronic citation was issued by the authorized user. Further, a complete historical record of the external user is also presented on the adjudication platform interface. The historical record may include previous citations issued to the offender or other prior incidents.

To resolve an electronic citation, or conclude the adjudication process for each electronic citation, the adjudication interface shall have a variety of actionable items which determine the ruling of the adjudication. The items include, but are not limited to, updating the judgment for the hearing, such as liable or not liable, adjusting the fine or fee amount, and scheduling a future court date. One skilled in the art will recognize that there are many appropriate resolutions to each citation that may be uniquely determined on a case-by-case basis by the judge or hearing officer.

Once the applicable options are chosen and submitted, the authorized user will return to the original list of electronic citations. An authorized user may return to any electronic citation at any point during the scheduled adjudication hearing.

The system interface further indicates the status of every electronic citation scheduled for that particular date and location. Various status indicators include in-progress, completed, or pending. However, one skilled in the art would recognize that there are many options for status indicators that will help ensure that the process runs smoothly and efficiently.

After a judgment has been successfully entered into the adjudication system for a particular electronic citation, the system payment portal become available for any external user that is required to pay a fine or fee. It is anticipated that the payment portal shall be made available via an interface both on the kiosk used for registering for adjudication as well as provided on a web interface that can be accessed via any computer with internet connectivity, similar to the payment process described above.

To successfully pay for an electronic citation, the external user must supply the electronic citation identification number as well as payment information, such as billing address and credit card information on the interface. Once submitted, the system shall verify and process the payment. The interface shall then notify the external user that a payment has been successfully received.

The system of this invention may also include a secure web application for authorized users. This is an interface for the management and creation of records, devices, and users of the system. To manage these records, login credentials are created and managed by authorized users acting as administrators interacting with the software. Such credentials are stored in the software's backend databases. These authorized users can create and manage profiles of other authorized users. Such profiles include, but is not limited to, usernames, passwords, security questions, personal identification information (text, voice, photo, or biometric), among others. It is anticipated that various permissions for authorized users exist. Some authorized users may have access to the secure web browser, while others may only have access to the software application on the mobile electronic device. Furthermore, other users may have access to the entire system. The database of all authorized users shall be stored and encrypted in the software relational database. When user credentials or other information is modified, created, or deleted, the information entered on the interface, using the secure web browser, is transmitted securely to the software web application for processing and sorting before being stored in the software relational database. Appropriate credentials may be entered in the form of a user name and password or swiping an identification card for access. One skilled in the art will recognize that any number of ways of entering security credentials may be employed depending on the needs of a user or requirements outlined by client preferences or existing laws or regulations. Once the credentials are entered into the web browser, a request is sent to a secure server for authentication and approval. The secure server houses a database of authorized persons and the credentials are cross-checked against the list. If there is a match, then the login was successful and the user is permitted access to the software. If there is not match, then login was unsuccessful and no access to the software is given.

Certain authorized users may be able to view the previous and current activity of all electronic devices. User monitoring includes tracking the electronic devices submitted reports and other activities performed by the authorized user that is using the software.

Authorized users of the secure web application shall have the ability to track all electronic devices by taking advantage of the GPS capability of each device. Coordinates can either be requested by the electronic device or taken at set intervals, pre-defined by the system. The web application shall have an interface that has the capability to display coordinates on a dynamic map.

Authorized users of the secure web application shall have the ability to remotely lock and wipe electronic devices in the field. Authorized users will be provided with an option within the secure web application to initiate a remote lock sequence in the event that an authorized user has failed to terminate his or her user session on the electronic device in the field. Additionally, the authorized users of the secure web application may also remotely wipe the devices. A remote wipe includes deleting all files and data stored on the device including, but not limited to, the application, citations, forms, reports, and personal user information.

The secure web browser shall also supply the authorized user with the ability to conduct advanced searches of the records stored in the software backend. An authorized user may search for citations, forms, or other reports by date, type, name, or any other relevant term. After entering the search term(s) the authorized user will be presented with a search result list that can be ordered or refined according to a set of predefined options, such as by date, alphabetical order, or type.

An authorized user may select an individual citation, form, or other report from the generated list. The selected report will then be transmitted from the software backend and presented in a readable format on the secure web browser. The authorized user then may be able to edit or add information according to predefined permissions in accordance with software specifications set by parameters of existing laws, rules, or regulations.

After making modifications, the authorized user may save the changes. The modified report shall then be securely transmitted to the software backend database for storage.

An authorized user may, at times, wish to generate entirely new citation, form, or report. The authorized user will be presented with a variety of required fields in which data will be entered. Upon entering all required data, the authorized user will submit the information to the software backend for error checking. Similar to the error checking process for the electronic device in the field, after successfully correcting errors, if any, the authorized user may submit the completed citation, form, or report for storage in the software database.

An authorized user may need to export or transmit certain citations, forms, or other report. The system has the ability to export such information into a variety of file formats, such as Extensible Markup Language (XML), spreadsheets and PDF documents. However, one skilled in the art would recognize that the system can be configured to export such information to many different file types and formats. Citations, forms, or other reports that are exported may then be electronically transferred using methods such as electronic mail (email) to other stakeholders of such information, such as the secretary of state, courts, or the department of transportation. Such files when transmitted may be encrypted and require certain login credentials to be viewable by an external stakeholder. After citations, forms, or other reports are exported, they may also be printed so that a physical copy is created. One skilled in the art would recognize that such information from the system can be reformatted in many ways so that it is in the desirable format for a physical copy. Such physical copies may have unique identifier labels, such as a number or barcode, so that an electronic copy could be easily retrieved from the software backend using the secure web interface. It is anticipated that an authorized user may have a barcode scanner to easily identify and retrieve electronic copies of physical copies.

Financial oversight of all transactions collected can also be monitored and tracked by the secure web browser. An authorized user of the secure web browser may view a list or any other depiction, such as a chart or graph, of all transactions that have occurred in accordance with a set of search parameters defined by the user. Search parameters include options such as time period, sort by information type, name, and others. The authorized user additionally will be presented with a complete list of both paid and unpaid citations/violations committed by External Users. The authorized user may retrieve a list of all uncollected fines/fees for purpose of auditing and requesting further action against delinquent payments. Furthermore, in addition to tracking payments, authorized user may export data into a variety of readable reports, such as spreadsheets or other data files.

### BRIEF DESCRIPTION OF THE SEVERAL VIEWS OF THE DRAWINGS

Possible and preferred features of the present invention will now be described with particular reference to the accompanying drawings. However, it is to be understood that the features illustrated in and described with reference to the drawings are not to be construed as limiting on the broad scope of the invention. In the drawings:

FIG. 1 is an overview flowchart of the system and method.

FIG. 2 is a flowchart relating to the login process.

FIG. 3 is a flow chart relating to the data collection process.

FIG. 4 is a flow chart relating to the data entry process.

FIG. 5 is a flow chart relating to the data submission process.

FIG. 6 is a flow chart relating to the backend process.

FIG. 7 is a flow chart relating to the process of transmission of data from the backend to the electronic device running the software.

FIG. 8 is a flow chart relating to the data comparison process.

FIG. 9 is a flow chart relating to the additional processing process.

FIG. 10 is a flow chart relating to the final submission process.

FIG. 11 is a flow chart relating to the printing process.

FIG. 12 is a flow chart relating to the log out process.

FIG. 13 is a flow chart relating to the voiding ticket process.

FIG. 14 is a flowchart relating to the adjudication process.

### DETAILED DESCRIPTION OF THE INVENTION

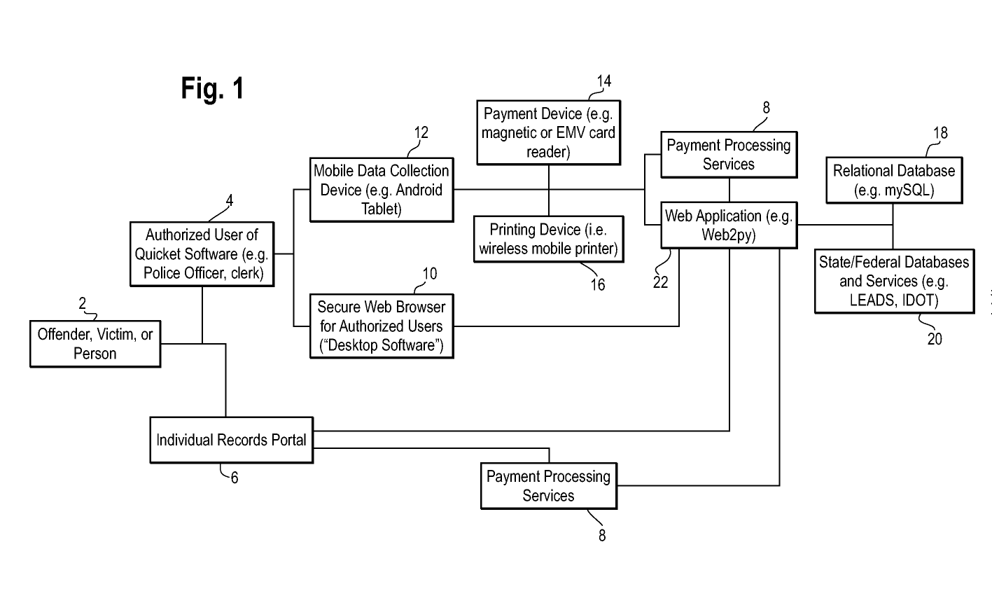

Turning now to the figures, FIG. 1 depicts an overview of the system and method of this invention. Typically, an individual 2 will trigger the initiation of the sequence of events that form this invention. An individual 2 may commit an offense or have some other event occur that will require an authorized user 4 to issue a citation 22 or other report. This will be completed by the authorized user 4 utilizing software to collect information on an electronic device 10, 12. This electronic device may be a mobile collection device 12 or a personal computer 10. After a citation has been issued, a payment device 14 may be utilized to process a payment or the citation 22 may be printed from a printer 16. In cases where a payment is presented, it may be presented to a payment processing server 8. The information collected because of this event may be cross-checked with either or both a software backend 18 or external backend 20. An individual 2 may also have access to a records portal 6 or payment processing 8 at a later time after the citation has been issued.

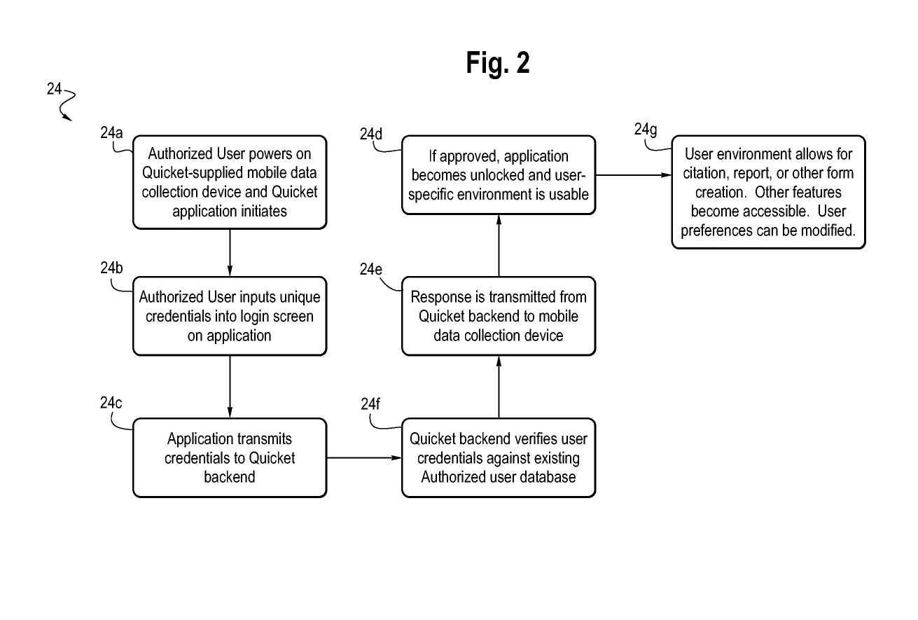

FIG. 2 depicts the method of logging into the software 24. The software 3 is initiated 24a on an electronic device 10, 12. An authorized user 4 inputs credentials 24b into the software. The credentials are checked for access 24c on the software backend. The software backend verifies the user on an existing authorized user database 24f. An authorized user 4 will receive the approval response 24e from the software backend 18 and will be transmitted to the electronic device 10, 12. If the credentials are approved 24d, the authorized user 4 is granted access. Features that are preferred by the authorized user are then enabled 24g.

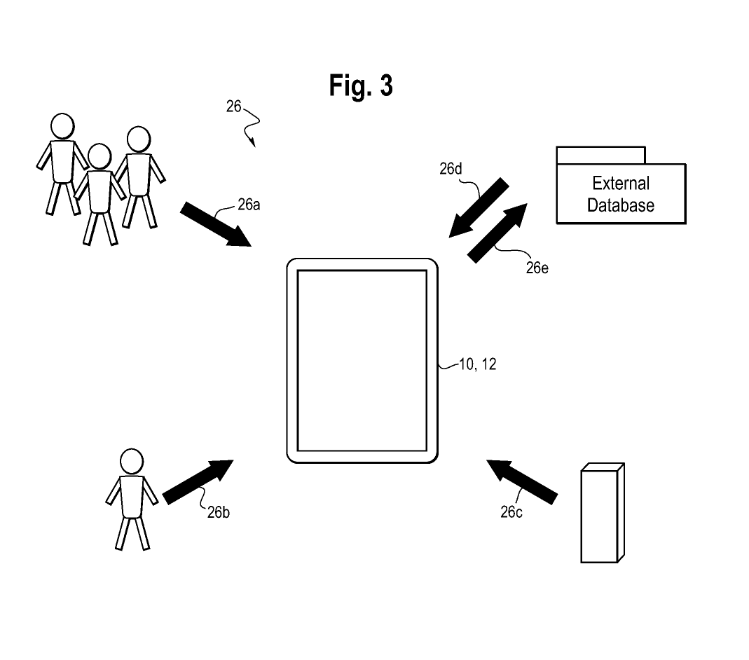

Turning next to FIG. 3, the data collection process 26 is outlined. Data can be collected and entered in the software on the electronic device 10, 12 by manual entry 26a, a no-consent manner 26b, or by the data capture method 26c. The manual entry 26a requires that the authorized user 4 manually input relevant information regarding an event triggering a citation. The no consent manner of entry 26b indicates that information has been inputted without any interaction with an external backend 20. The data capture method 26c indicates that a driver's license has been scanned to populate a form, as an example. The electronic device 10, 12 then transmits then queries 26d the external database 18 and also is able to receive a response with existing records 26e.

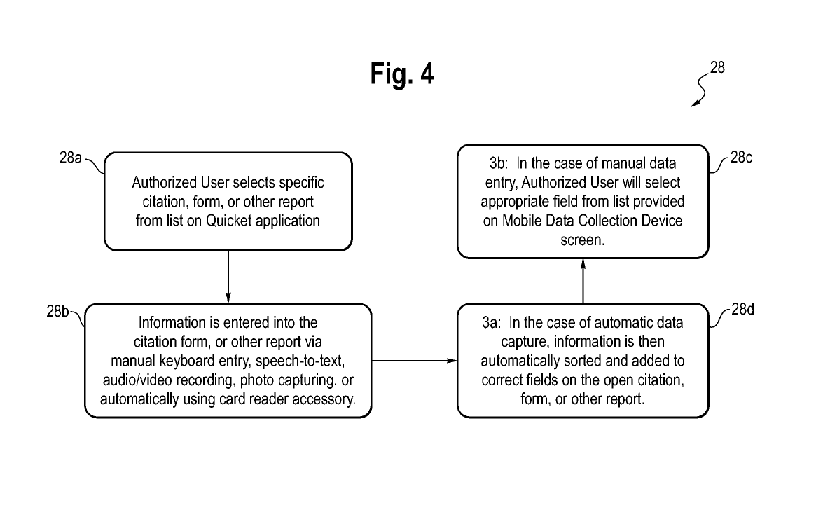

Turning now to FIG. 4 the data entry process 28 is outlined. A user first selects the appropriate form 28a for the entry of data. Information is entered 28b into the form using a variety of manners. If the authorized user 4, requests external backend 20 input, information may be automatically added 28d to the form. An authorized user may also manually input data 26a and will select fields 28c from a list to manually input data.

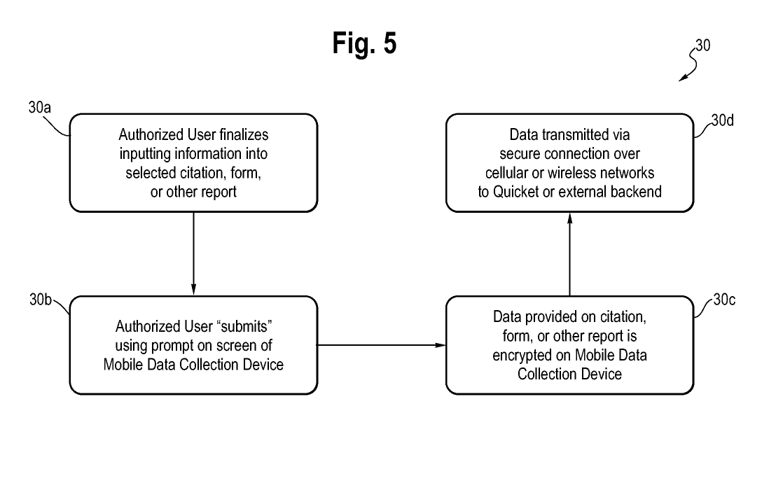

FIG. 5 outlines the data submission process 30. The authorized user 4 finalizes the information 30a. The authorized user 4 then submits the information via a submit prompt 30b. Data is then encrypted 30c on the electronic device and then transmitted via secure connection to the backends 18, 20 (seen in 30d).

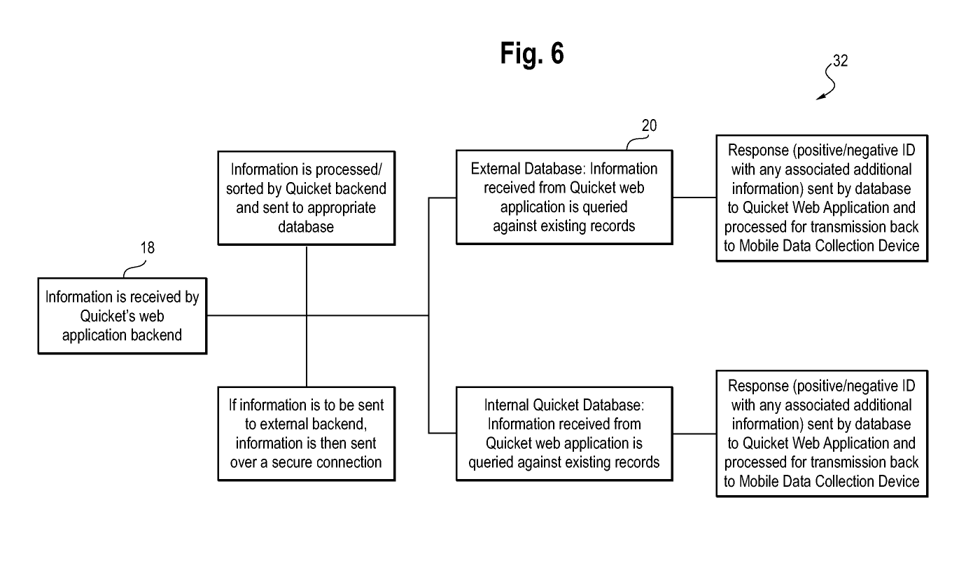

FIG. 6 outlines the backend process 32. The transmitted data is received by the software backend 18 and is processed by the software backed 18. If the data is to be sent to an external backend 20, then the data is transmitted in a manner acceptable by that external backend 20. The information is then cross-checked on the backends 18, 20 for matches.

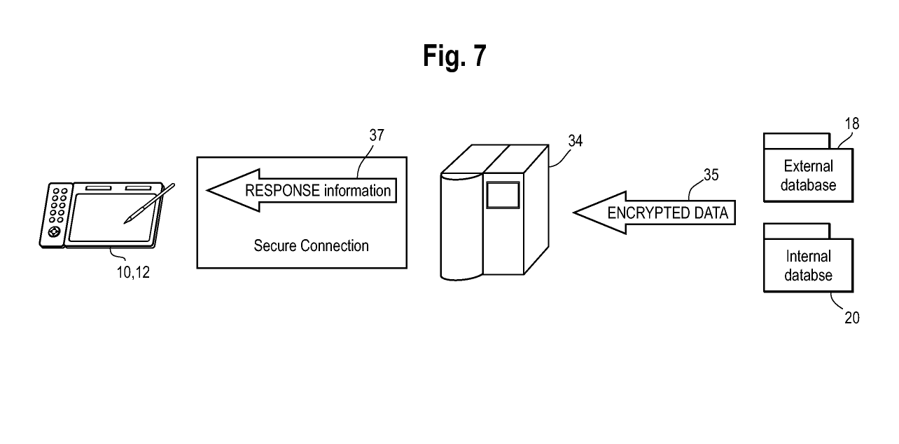

FIG. 7 outlines the process of transmission of data from the backend to the electronic device 10, 12 running the software 34. The encrypted data 35 is transmitted from the backends 18, 20 to the software 34 which processes and/or sorts information into a format that is received by the electronic device 10, 12.

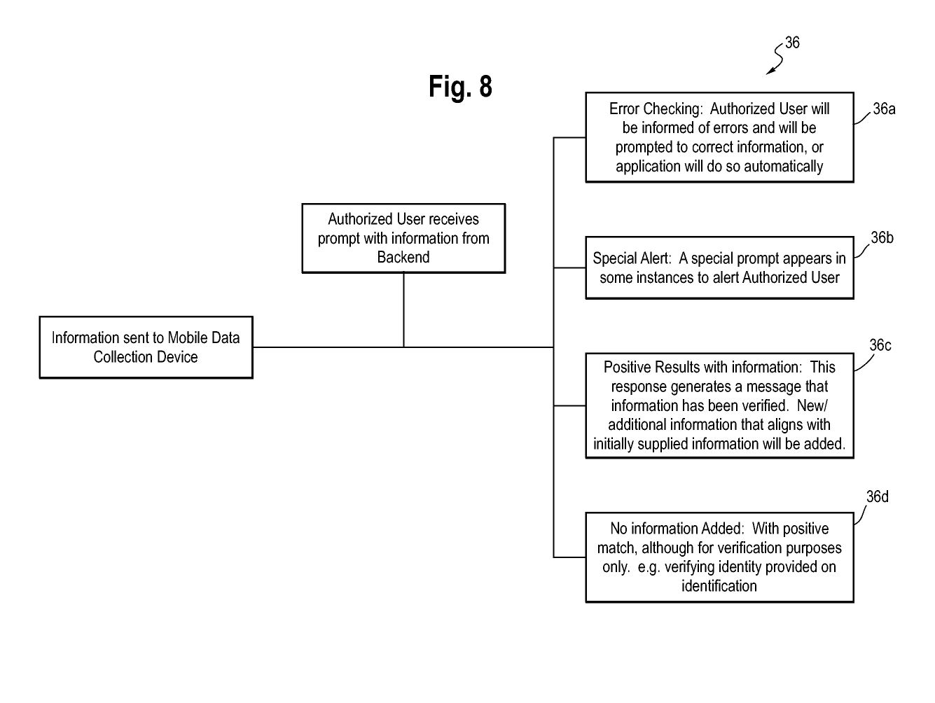

FIG. 8 outlines the data comparison process 36. The data collected is checked against the backends 18, 20 for errors 36a, special circumstances 36b. A positive match 36c with the backends 18, 20 may result in data being verified. There may be instances where no match 36d is made.

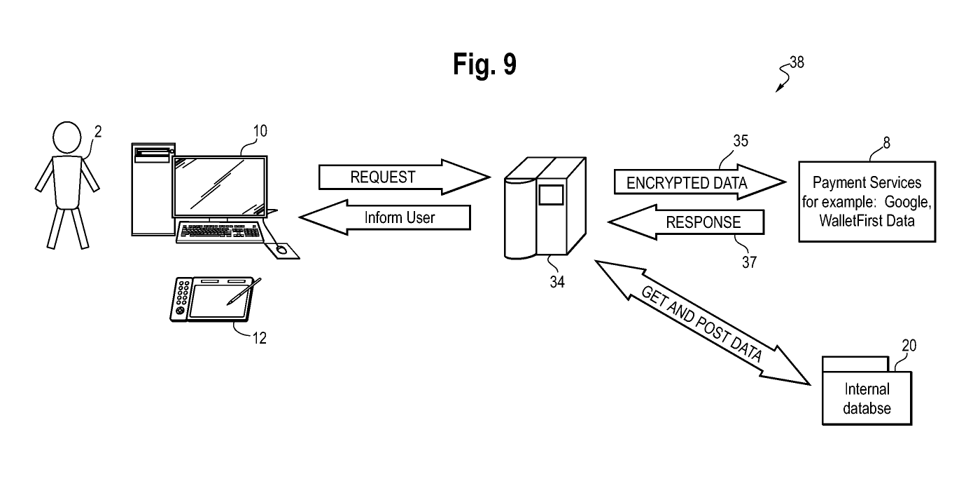

FIG. 9 outlines the additional processing process 38. Payment services 8 can be enabled by the software 34. Information is inputted by a user 2 and is sent from the electronic device 10, 12 through the software 34 to generate a fee that is due. The software 34 sends data to and can receive data from the internal backend 20. Once the data is processed, a fee can be generated. That fee can then be collected and processed.

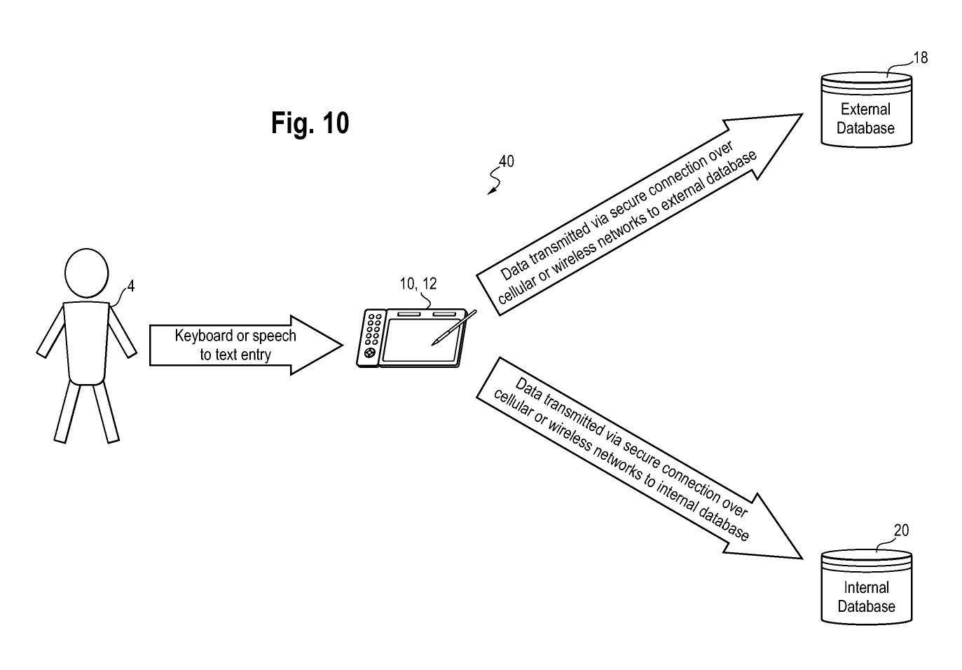

FIG. 10 outlines the final submission process 40. After the data has been collected and entered into the electronic device 10, 12 and the authorized user 4 believes that the citation 22 is complete, a citation 22 may be issued. Data is transmitted to an external backend 18 via a secure connection over cellular or wireless networks. Data is also transmitted to an internal backend 20 via a secure connection over cellular or wireless networks.

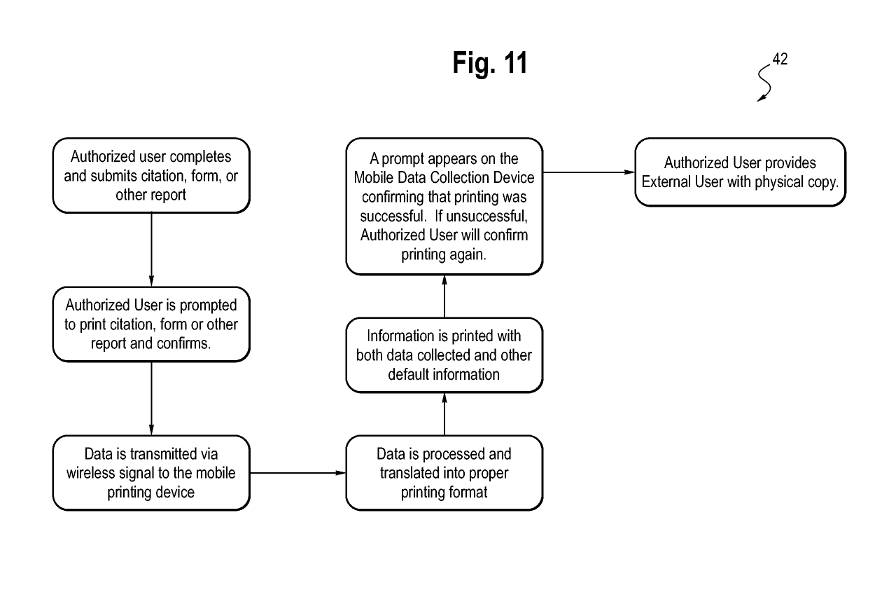

FIG. 11 outlines the printing process 42. An authorized user 4 will provide the individual 2 with a copy of the citation 22. This can be achieved by submitting the citation 22 to a printer 16.

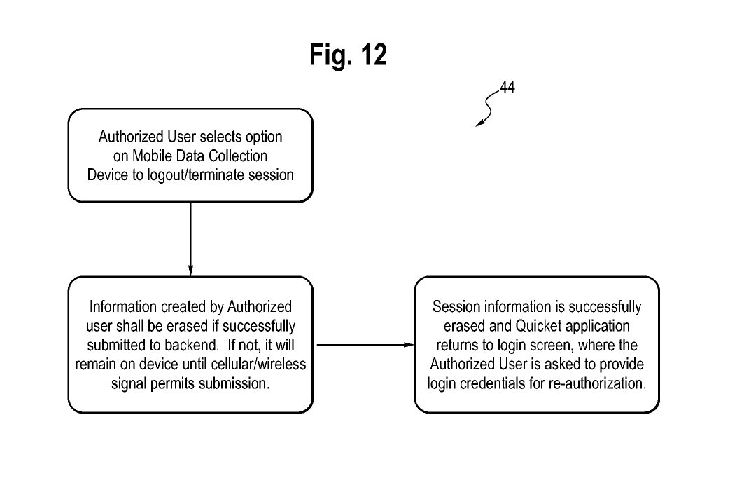

FIG. 12 details the log out process 44. When an authorized user 4 no longer needs access to the software 3, the logging out process 44 is enabled. This results in the software 3 being closed and no data being stored on the electronic device 10, 12 except in special circumstances. Access will be denied until appropriate credentials are re-entered.

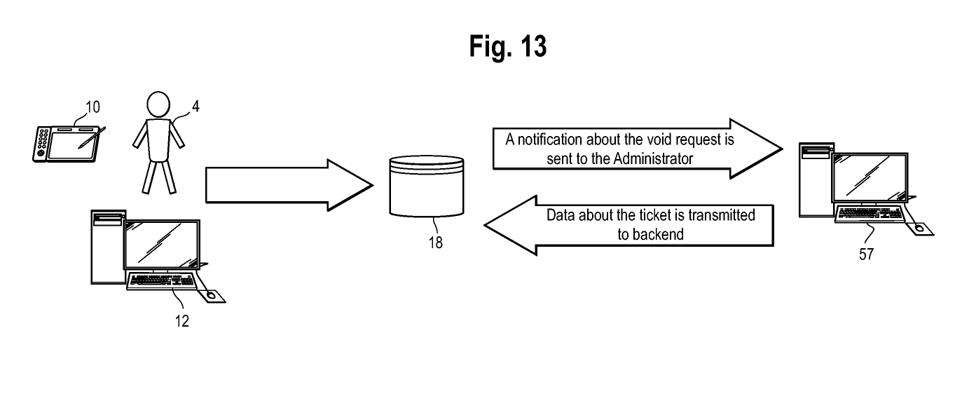

FIG. 13 details the process of voiding a ticket. An authorized user 4 selects a ticket to void on the electronic device 10, 12 and this information is sent to an external backend 18. The request is processed by an administrator 57 who then approves or denies the request. The response from the administrator is then transmitted to the external backend 18.

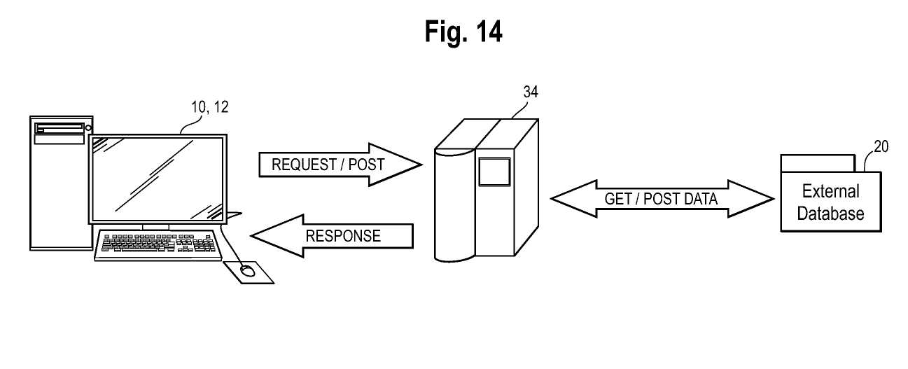

FIG. 14 depicts the adjudication process. A user enters data into the software 34 for processing by the internal database 20. This data can be searched for adjudication results.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

What is claimed is:

1. The system of issuing and monitoring citations comprising:
an electronic device equipped with software for issuing and monitoring citations linked to at least one secure server;
wherein an authorized user collects and enters data regarding an event and transmits the information to at least one secure backend for a cross-check for accuracy, completeness, or for more information regarding the citation; and transmits the citation to an appropriate agency for monitoring or processing via secure server and sends permission to issue a citation to at least one individual.

2. The system of claim 1 wherein the electronic device is a mobile collection device such as a mobile phone or other mobile electronic device capable of transmitting and receiving information.

3. The system of claim 1 wherein the software requires that security credentials are entered before allowing access for use.

4. The system of claim 1 wherein the authorized user collects and then enters data into the software using pre-defined parameters set by the software.

5. The system of claim 1 wherein the at least one secure server is a software backed and/or at least one external or internal backend.

6. The system of claim 5 wherein the software backed and/or at least one external backend accepts, processes, manipulates, and stores the information regarding the citation and ensures that the authorized user has appropriately entered the data for the issuance of a citation.

7. The system of claim 1 further comprising payment processing or court date issuance.

8. The system of claim 1 further comprising at least one records portal accessing via secure web browser.

9. The system of claim 1 wherein an authorized user or the individual receiving the citation can access the records portal; accessibility of the records portal is given through credentialing.

10. The system of claim 1 further comprising a means for adjudication of a citation.

11. A method of issuing and monitoring citations comprising the steps of:
an authorized user using an electronic device to log into software equipped with means to issue and monitor citations;
the authorized user collecting data from at least one individual or event regarding that event that would trigger the issuance of a citation and enters the data into the software;
submitting the data to an appropriate agency wherein at least one secure server accepts, processes, manipulates and stores the data for completeness, accuracy, or for the purposes of informing the authorized user of additional information that may be relevant to the person;
at least one secure server sends a response back to the authorized user's electronic device as to whether the data is acceptable or not; and
the authorized user issuing a citation to the at least one individual.

12. The method of claim 11 wherein the electronic device is a mobile collection device such as a mobile phone or other mobile electronic device capable of transmitting and receiving information.

13. The method of claim 11 wherein the authorized user collects and then enters data into the software using pre-defined parameters set by the software.

14. The method of claim 11 wherein the at least one secure server is a software backed and/or at least one external or internal backend.

15. The method of claim 14 further comprising the steps of the software backed and/or at least one external backend accepting, processing, manipulating, and storing the information regarding the citation and ensuring that the authorized user has appropriately entered the data for the issuance of a citation.

16. The method of claim 11 further comprising the step of payment processing or court date issuance.

17. The method of claim 11 further comprising the step of accessing a records portal via a secure web browser.

18. The method of claim 17 further comprising the step of an authorized user or the individual receiving the citation accessing the records portal; accessibility of the records portal is given through appropriate credentialing.

19. The method of claim 11 further comprising the step of adjudication of the citation.
